(19) United States
(12) Patent Application Publication
(10) Pub. No.: US 2006/0201638 A1
(43) Pub. Date: Sep. 14, 2006

(54) Panel pet door

(76) Inventor: Mark Richard Hesketh, Huby (GB)

Correspondence Address: CARSTENS & CAHOON, LLP, P O BOX 802334, DALLAS, TX, 75380, US

(21) Appl. No.: 11/074,437

(22) Filed: Mar. 8, 2005

(51) Int. Cl. E06B 7/28

(52) U.S. Cl. 160/180

(57) ABSTRACT

A panel pet door comprises a lower panel and an upper panel disposed above the lower panel to form the panel pet door, a pet flap inserted into the lower panel, the lower and upper panels each having a hinge mechanism on one side thereof so as to have a common hinged edge of the panel pet door, the lower and upper panels being separate, whereby they can be independently opened about the respective hinge mechanism when fitted by the hinged mechanisms within an opening in a patio door, and an upper locking member located along an upper edge of the upper panel and a lower locking member located along a lower edge of the lower panel. The hinge mechanism accommodates an outwardly protruding handle on the patio door and permits the panel pet door to be folded back fully so as to be substantially against the patio door. The panel pet door may be provided as a kit of parts.

### BACKGROUND OF THE INVENTION

1. Technical Field

The present invention relates to a panel pet door and in particular to a panel pet door for insertion into a sliding patio door frame. The present invention also relates to a kit of parts for such a panel pet door, to enable the door to be assembled by a purchaser. The present invention further relates to a hinge mechanism a panel pet door.

2. Description of Related Art

Panel pet doors are known which are adapted to fit into a sliding patio door opening of a building, in particular a domestic building such as a house. To install the panel pet door, the sliding patio door is partially opened, the panel pet door is inserted into the opening provided by the sliding patio door frame, and the sliding patio door is closed against the panel pet door so that the panel pet door is secured between the frame of the patio door and the sliding patio door. The panel pet door can be locked in position so as to maintain the security of the property against intruders. The panel pet door includes a pet flap, selectively dimensioned for the required dog or cat of the owner, to permit egress and ingress of the pet from and into the building.

Such panel pet doors have been known for more than 30 years. For example, such panel pet doors are known from U.S. Pat. No. 3,654,733 (Blackwell), U.S. Pat. No. 3,811,224 (Garrison), U.S. Pat. No. 3,878,645 (Porter), U.S. Pat. No. 3,918,203 (Ellison Jr), U.S. Pat. No. 4,047,331 (Davlantes), U.S. Pat. No. 4,408,416 (Davlantes), U.S. Pat. No. 5,185,954 (Waddle Sr.) and U.S. Pat. No. 6,691,483 (Lethers). Such a panel pet door is also disclosed in Canadian Patent Specification No. 2367844 (Isberg).

U.S. Pat. No. 3,654,733 (Blackwell) discloses a pet-door-containing insert unit which has the same height as the sliding patio door and includes a top edge for fitting into an upper sliding-door trackway means. In order to positively prevent unauthorized removal of the sliding door, a block may be positioned in the upper trackway means at a location so as positively to prevent the upper frame portion of the sliding door from been moved upwardly to a degree sufficient to allow it to be removed entirely from the sliding door frame.

U.S. Pat. No. 3,811,224 (Garrison) discloses a pet door panel comprising a pre-fabricated panel structure with a lower hinged pet door.

U.S. Pat. No. 3,878,645 (Porter) discloses a pet door device in which a top door panel and a bottom door panel are connected by a horizontally extending hinge. A swinging door panel is provided in the bottom door panel and a fastener is provided at the upper edge of the top panel which is hand operated for locking the upper edge of the pet door device.

U.S. Pat. No. 3,918,203 (Ellison Jr) discloses a pet access panel including swinging doors. The panel is adapted to be attached to a sliding door or similar structure by an attachment means such as a U-shaped end portion.

U.S. Pat. Nos. 4,047,331 and 4,408,416 (Davlantes) disclose a pet access door panel in which slidable latches can be fitted into prepared apertures in the frame rail and the sill to secure the door panel.

U.S. Pat. No. 5,185,954 (Waddle Sr) discloses a pet portal device which may be hingedly attached to a sliding door. This device suffers from the problem that the pet portal device cannot be fully opened so as to be folded back flush against the sliding door. This is because the protruding handle of the sliding door prevents such folding back. This is a significant disadvantage to a user.

U.S. Pat. No. 6,691,403 (Lethers) discloses an adjustable pet door incorporating a panel door frame and a movable door flap assembly which can slide vertically on the panel door frame along tracks in the vertical panel door frame. Riser spacer panels are also mounted on the panel door frame and are also vertically slidable on the frame via the vertical tracks. The door flap assembly and space are selectively removable and replaced to effect a change in the rise and the height of the door flap assembly.

Canadian Patent Application No. 2367844 (Isberg) discloses a portable pet door comprising a horizontally compressible elongated planar body in which two elongated members are joined and held separate by a pair of semi-stiff springs.

A number of the known panel pet doors that are disclosed in these prior specifications, and also a number of known panel pet doors that are commercially available in the United States, suffer from some technical and commercial problems.

The units are constructed as a pre-assembled “one piece” unit to enable ready insertion of the unit by the purchaser into the sliding patio door frame, requiring minimal assembly work by the purchaser when the unit is received, most typically by mail order, by the purchaser. This particularly applies to panel pet doors which are sold and intended for use as “temporary” installations where no tools are required by the purchaser and the panel is simply intended to be inserted into the sliding patio door frame by the purchaser.

However, such known constructions are required to be full length door panels which are accordingly not only cumbersome and expensive to ship, but also tend to result in an unversatile construction with regard to shapes and dimensions of the panel pet door. In addition, since for the safety and security purposes the panel pet door incorporates a toughened glazing unit, which may be single or double glazed, above the pet flap, this adds significant weight to the unit, and results in a rather unversatile construction.

Of the prior patents discussed above, U.S. Pat. No. 3,878,645 (Porter) discloses a pet door device in the form of a panel pet door having a central horizontally extending hinge connected between top and bottom door panels made of, for example, wood or metal, the hinge permitting the door to be folded in half for storage and carrying purposes. However, the provision of such a hinge still presents in a rather clumsy and unversatile construction.

In the more modem panel pet door constructions, for example as exemplified in U.S. Pat. No. 6,691,483 (Lethers), the upper edge of the panel pet door incorporates, a helical compression spring mechanism located above the top horizontal frame cross piece of the door frame. The spring mechanism supports a rail which is inserted into a top track of the sliding patio door frame. On each of the two vertical frame uprights of the frame a thumb screw is provided which is located on the interior side of the panel door frame. The thumb screw when tightened bears against a respective rod of the spring mechanism such that the spring mechanism is locked in place when the thumb screw is tightened, and unlocked when loosened. In this way, the rod is biased by the helical compression spring in an upwardly direction so that the movable rail mounted on the rods is biased upwardly into a locking configuration with the sliding patio door frame. Such a compression spring arrangement can be rather tricky to operate.

### SUMMARY OF THE INVENTION

The present invention aims to solve or at least mitigate one or more of the problems of the known panel pet doors discussed hereinabove.

Accordingly, in one aspect the present invention provides a panel pet door comprising a lower panel and an upper panel disposed above the lower panel to form the panel pet door, a pet flap inserted into the lower panel, the lower and upper panels each having a hinge mechanism on one side thereof so as to have a common hinged edge of the panel pet door, the lower and upper panels being separate, whereby they can be independently opened about the respective hinge mechanism when fitted by the hinged mechanisms within an opening in a patio door, and an upper locking member located along an upper edge of the upper panel and a lower locking member located along a lower edge of the lower panel.

Preferably, each locking member is a reciprocable biased locking element normally biased to a retracted position by at least one biasing element mounted between the locking element and a frame of the respective panel.

Preferably, the panel pet door further comprises at least one sliding member within the frame of the respective panel which is connected to the locking element and extends downwardly into the frame and at least one manually operable lock located on a face of the respective frame for locking the respective sliding member in a selected position.

Preferably, the lower and upper panels have substantially the same height.

In another aspect, the present invention also provides a kit of parts for a panel pet door, the kit comprising first and second panels and a locking member located along an end edge of each of the first and second panels.

Preferably, the lower and upper panels have substantially the same height.

The kit of parts for a panel pet door may further comprise a hinge mechanism on one side of each of the first and second panels whereby when the first and second panels are assembled one above the other with the locking members at opposed ends of the assembly, there is a common hinged edge of the assembled panel pet door.

Preferably, each locking member is a reciprocable biased locking element normally biased to a retracted position by at least one biasing element mounted between the locking element and a frame of the respective panel.

The kit of parts for a panel pet door may further comprise at least one sliding member within the frame of the respective panel which is connected to the locking element and extends downwardly into the frame and at least one manually operable lock located on a face of the respective frame for locking the respective sliding member in a selected position.

The kit of parts for a panel pet door may further comprise a removable glazing for each of the first and second panels.

The kit of parts for a panel pet door may further comprise a removable pet flap for fitting to the glazing of one of the first and second panels.

In another aspect, the present invention also provides a hinge element for a panel pet door comprising four interconnected hinge plates serially connected by three parallel hinge axes.

Preferably, the four interconnected hinge plates comprise a first end hinge plate provided with through screwholes, a first central hinge plate, a second central hinge plate and a second end hinge plate provided with through screwholes, there being a first hinge axis between the first end hinge plate and the first central hinge plate, a second hinge axis between the first central hinge plate and the second central hinge plate, a third hinge axis between the second central hinge plate and the second end hinge plate.

Preferably, the first hinge axis is adapted to permit the first central hinge plate to be rotated relative to the first end hinge plate by an angle of up to 90°.

Preferably, the second hinge axis is adapted to permit the first and second central hinge plates to be rotated relative to each other by an angle of up to about 180°.

Preferably, the third hinge axis is adapted to permit relative rotation between the second central hinge plate and the second end hinge plate by an angle of up to 90°.

Preferably, when each of the first hinge, the second hinge and the third hinge are completely opened, the first end hinge plate and the second end hinge plate are substantially mutually parallel.

Preferably, when the first hinge between the first end hinge plate and the first central hinge plate is closed, a surface of the first end hinge plate lies adjacent a surface of the first central hinge plate, when the second hinge is closed, a first surface of the second central hinge plate lies adjacent the surface of the first central hinge plate, and when the third hinge is closed, a surface of the second end hinge plate lies adjacent a second surface of the second central hinge plate.

Preferably, the width of the second end hinge plate and the second central hinge plate are substantially the same.

Preferably, the width of the first end hinge plate is substantially the same as the width of the second end hinge plate.

Preferably, when the hinge element is in a completely closed configuration the first end hinge plate and the combination of the second central hinge plate and the second end hinge plate are folded so as to lie wholly within the width of the first central plate.

Preferably, the first central plate is approximately twice the width of any of the first end hinge plate, the second central hinge plate and the second end hinge plate.

Preferably, the first hinge axis between the first end hinge plate and the first central hinge plate is of a first hinge which opens in a first rotational direction, the second hinge axis between the first central hinge plate and the second central hinge plate is of a second hinge which opens in a second, opposite, rotational direction, and the third hinge axis between the second central hinge plate and the second end hinge plate is of a third hinge which opens in the first rotational direction.

In another aspect, the present invention also provides a panel pet door comprising a lower panel and an upper panel disposed above the lower panel to form the panel pet door, a pet flap inserted into the lower panel, the lower and upper panels each having a hinge mechanism on one side thereof so as to have a common hinged edge of the panel pet door, the lower and upper panels being separate, whereby they can be independently opened about the respective hinge mechanism when fitted by the hinged mechanisms within an opening in a patio door, each hinge mechanism comprising at least one hinge element comprising four interconnected hinge plates serially connected by three parallel hinge axes, the four interconnected hinge plates comprising a first end hinge plate, a first central hinge plate, a second central hinge plate and a second end hinge plate, there being a first hinge axis between the first end hinge plate and the first central hinge plate, a second hinge axis between the first central hinge plate and the second central hinge plate, a third hinge axis between the second central hinge plate and the second end hinge plate, and one end hinge plate selected from the group consisting of the first end hinge plate and the second end hinge plate being affixed to the said one side of the respective panel and the other end hinge plate being adapted to be fitted to a patio door.

Preferably, the lower and upper panels have substantially the same height.

Preferably, the first hinge axis is adapted to permit the first central hinge plate to be rotated relative to the first end hinge plate by an angle of up to 90°.

Preferably, the second hinge axis is adapted to permit the first and second central hinge plates to be rotated relative to each other by an angle of up to about 180°.

Preferably, the third hinge axis is adapted to permit relative rotation between the second central hinge plate and the second end hinge plate by an angle of up to 90°.

Preferably, when each of the first hinge, the second hinge and the third hinge are completely opened, the first end hinge plate and the second end hinge plate are substantially mutually parallel.

Preferably, when the first hinge between the first end hinge plate and the first central hinge plate is closed, a surface of the first end hinge plate lies adjacent a surface of the first central hinge plate, when the second hinge is closed, a first surface of the second central hinge plate lies adjacent the surface of the first central hinge plate, and when the third hinge is closed, a surface of the second end hinge plate lies adjacent a second surface of the second central hinge plate.

Preferably, the width of the second end hinge plate and the second central hinge plate are substantially the same.

Preferably, the width of the first end hinge plate is substantially the same as the width of the second end hinge plate.

Preferably, when the hinge element is in a completely closed configuration the first end hinge plate and the combination of the second central hinge plate and the second end hinge plate are folded so as to lie wholly within the width of the first central plate.

Preferably, the first central plate is approximately twice the width of any of the first end hinge plate, the second central hinge plate and the second end hinge plate.

Preferably, the first hinge axis between the first end hinge plate and the first central hinge plate is of a first hinge which opens in a first rotational direction, the second hinge axis between the first central hinge plate and the second central hinge plate is of a second hinge which opens in a second, opposite, rotational direction, and the third hinge axis between the second central hinge plate and the second end hinge plate is of a third hinge which opens in the first rotational direction.

In another aspect, the present invention also provides a kit of parts for a panel pet door, the kit comprising first and second panels, and a hinge mechanism on one side of each of the first and second panels whereby when the first and second panels are assembled one above the other to form a panel pet door, there is a common hinged edge of the assembled panel pet door, each hinge mechanism comprising at least one hinge element comprising four interconnected hinge plates serially connected by three parallel hinge axes, the four interconnected hinge plates comprising a first end hinge plate, a first central hinge plate, a second central hinge plate and a second end hinge plate, there being a first hinge axis between the first end hinge plate and the first central hinge plate, a second hinge axis between the first central hinge plate and the second central hinge plate, a third hinge axis between the second central hinge plate and the second end hinge plate, and one end hinge plate selected from the group consisting of the first end hinge plate and the second end hinge plate being affixed to the said one side of the respective panel and the other end hinge plate being adapted to be fitted to a patio door.

Preferably, the lower and upper panels have substantially the same height.

The kit of parts for a panel pet door may further comprise a locking member located along an end edge of each of the first and second panels.

Preferably, each locking member is a reciprocable biased locking element normally biased to a retracted position by at least one biasing element mounted between the locking element and a frame of the respective panel.

The kit of parts for a panel pet door may further comprise at least one sliding member within the frame of the respective panel which is connected to the locking element and extends downwardly into the frame and at least one manually operable lock located on a face of the respective frame for locking the respective sliding member in a selected position.

The kit of parts for a panel pet door may further comprise a removable glazing for each of the first and second panels.

The kit of parts for a panel pet door may further comprise a removable pet flap for fitting to the glazing of one of the first and second panels.

### BRIEF DESCRIPTION OF THE DRAWINGS

Embodiments of the present invention will now be described, by way of example only, with reference to the accompanying drawings, in which:

FIG. 1 is a front elevational view of a panel pet door in accordance with an embodiment of the present invention when inserted into a sliding patio door frame;

FIG. 2 is an enlarged front elevational view, partly in phantom, of an upper portion of the panel pet door of FIG. 1;

FIG. 3 is a perspective view of a hinge element in accordance with another embodiment of the invention in a closed configuration;

FIG. 4 is a plan view of the hinge element of FIG. 3 in a closed configuration;

FIG. 5 is a perspective view of the hinge element of FIG. 3 in an open configuration;

FIG. 6 is a plan view of the hinge element of FIG. 3 in an open configuration;

FIG. 7 is a plan view of the hinge element of FIG. 3 in a closed configuration when fitted between a panel pet door and a patio door;

FIG. 8 is a plan view of the hinge element of FIG. 3 in a partly open configuration when fitted between a panel pet door and a patio door; and

FIG. 9 is a plan view of the hinge element of FIG. 3 in a fully open configuration when fitted between a panel pet door and a patio door.

### DETAILED DESCRIPTION OF THE PREFERRED EMBODIMENTS

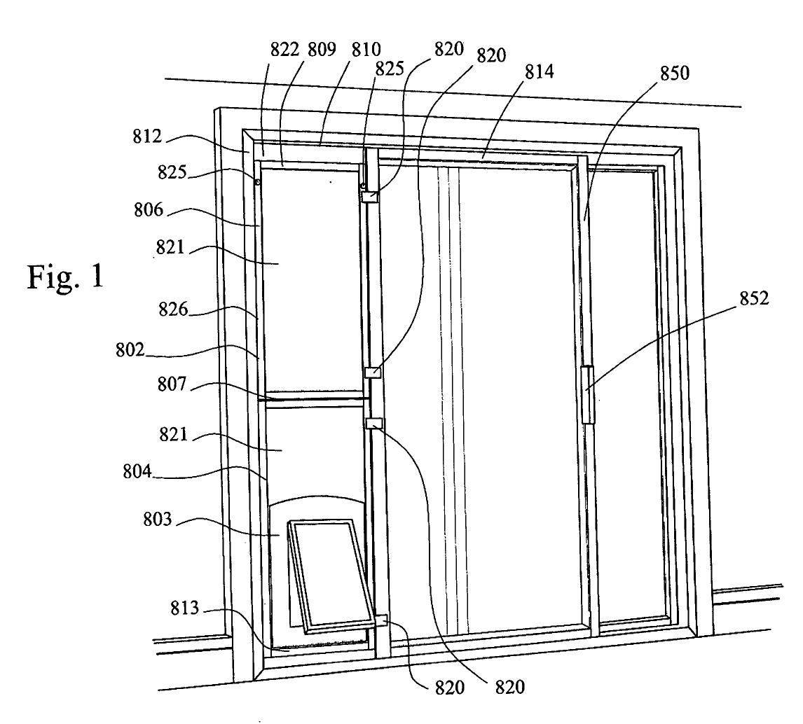

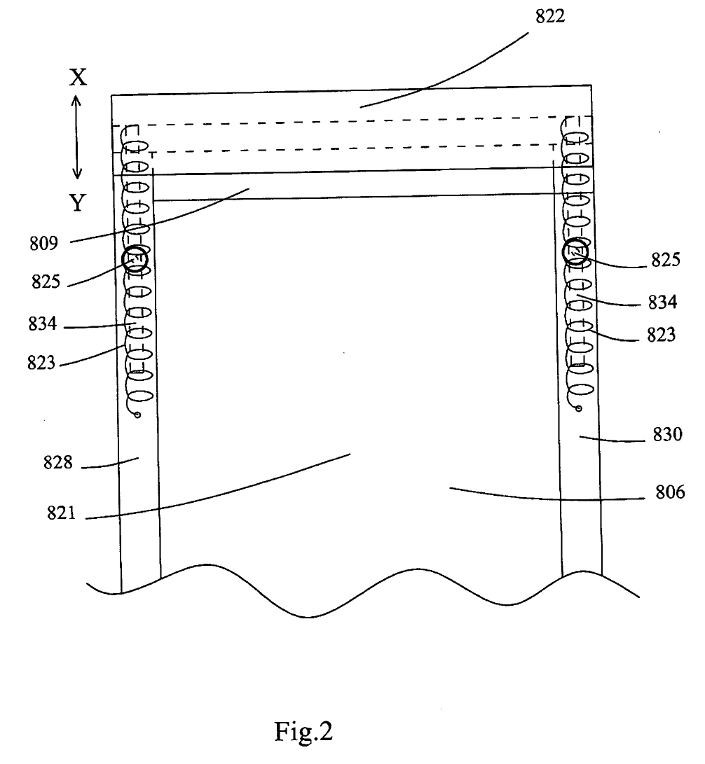

An embodiment of a panel pet door in accordance with the present invention is illustrated in FIGS. 1 and 2.

In this embodiment, the panel pet door (802) comprises a lower panel (804) and an upper panel (806). A pet flap (803) is inserted into the lower panel (804). The lower and upper panels (804, 806) are separate although a sealing gasket (807) is disposed therebetween, typically fitted to the upper edge of the lower panel (804). The lower and upper panels (804, 806) have the same width and also the same height. The lower and upper panels (804, 806) are disposed one above the other to form the panel pet door, but each can be independently opened. The lower and upper panels (804, 806) when assembled together define a generally elongate rectangular door (802) having opposed side edges which are intended, in use, to abut and be flush with, respectively, a sliding patio door frame (812) and a sliding patio door (814), disposed in a partially open position. The lower panel (4) defines a lower edge of the panel pet door (802) which is intended to be fitted to a sill of the sliding patio door frame (812) and the upper panel (806) incorporates along its upper edge a locking element (822) which is adapted to be locked into a locked configuration in an upper track of the sliding patio door frame (812).

As already known in the art, the lower panel (804) includes a peripheral lower frame typically composed of extruded metal, such as aluminum, and a lower sheet assembled within the lower frame, with a peripheral edge of the lower sheet being securely and sealingly received, by use of appropriate beading or gaskets, within a peripheral channel of the lower frame. The pet flap (803) is mounted on the lower sheet at a desired location for access by the pet for ingress and egress of the building.

The upper panel (806) similarly includes a peripheral upper frame within which is fitted a glazing, which may be single or multiple-ply glazing and composed of transparent or translucent glass, most preferably toughened glass, and/or plastics material, such as a polycarbonate or acrylic sheet. The peripheral edge of the glazing is fitted into an inwardly directed peripheral channel of the upper frame together with associated gaskets and/or beading. As for the lower frame, the structural frame members of the upper frame are composed of an extruded metal, such as aluminum.

When the lower and upper panels (804, 806) are assembled together in an opening (810) in a sliding patio door frame (812) adjacent a sliding patio door (814) disposed in a partially slid-open position as shown in FIG. 1, the lower and upper panels (804, 806) are individually hinged, along a common hinged edge of the panel pet door, by respective pairs of hinge elements (820) either to the sliding patio door (814) as shown in FIG. 1 or, alternatively, to the sliding patio door frame (812).

The upper panel (806) is provided with a reciprocable biased sliding locking element (822) along its upper edge (809). The locking element (822) can move up or down as shown by the arrow X-Y in FIG. 2. As shown in FIG. 2, the locking element (822) is normally biased to a retracted position (in direction Y) by a pair of tension springs (823) mounted between the locking element (822) and upright frame members (828, 830) of the upper frame. The tension springs (823) are respectively concealed within the upright frame members (828, 830) of the upper frame. Two sliding members (834) are provided, also respectively concealed within the upright frame members (828, 830) of the upper frame, which are connected to the locking element (822) and extend downwardly into the upright frame numbers (828, 830).

When it is desired to lock the locking element (822) in position against the frame (812) of the sliding door, a user manually pushes up the locking element (822) (in direction X) into secure engagement with the frame (812), against the bias of the tension springs (823), and then the locking element (822) is locked in position by rotating two knurled knobs (825), provided on the inside face (826) of the upright frame members (828, 830), which lock the sliding members (834) in position. This secures the upper panel (806) in the opening and prevents unauthorised opening of the upper panel (806) from outside the building. The same operation is carried out, but in a downward rather than upward direction, for locking the lower panel (804) into the sill of the patio door frame.

When it is desired to open either the upper or lower panel, which may be done selectively because they are separated and can be individually opened about their respective hinges, a user unscrews the respective pair of knurled knobs (825) and this causes the tension springs (823) automatically to retract the respective locking element (822) from either the upper portion or the sill of the patio door frame. The panel can then be swung open, free of the patio door frame. The panels can be locked again in position by the opposite actions, namely extending the locking element against the bias of the tension springs and then screwing the knurled knobs to lock the locking element in position. This is a convenient arrangement for the user, particularly when opening the panels of the panel pet door.

The construction of the present invention incorporating tension springs which retract the locking elements at the top and bottom edges of the panel pet door is the opposite of known constructions where a compression spring is used and the locking element is manually pulled downwardly against the bias of the helical compression springs. The construction of the present invention can be more easily implemented by the consumer because, at least, pushing away a relatively near edge of the locking element is easier than pulling towards one a more remote edge that is being slotted into the door frame at the same time. It also makes the hinged panel easier to open.

When it is desired to open the upper panel (806), for example by rotating it about the hinge elements (820), then the knurled knobs (825) are rotated so as to release the sliding members (834), the locking element (822) is pulled downwardly by the bias of the tension springs (823), so as to release the locking element (822) from the frame (812), and then the upper panel (806) can be opened. Since the upper panel (806) is separate from the lower panel (804), the upper panel (806) can be opened about its hinge elements (820) without requiring opening of the lower panel (804).

A similar locking configuration incorporating a locking element (822) is provided on the lower edge (813) of the lower panel (804). Since the lower panel (804) and the upper panel (806) have, in this preferred embodiment, the same height, they may be alternatively and selectively fitted either to the sliding patio door (814), as shown in FIG. 1, or alternatively on the other side to the fixed frame (812) of the patio door even with the hinge elements (820) being pre-fixed to the lower and upper panels (804, 806). This is because for hinging, as an alternative, on the left-hand side, as opposed to the right-hand side (as shown in FIG. 1), the lower and upper panels (804, 806) can simply be inverted by being rotated about 180° so that the lower panel becomes the upper panel and vice versa. Since the glazings (821) are removable from the lower and upper panels (804, 806), the pet flap (803) can be inserted into one panel or the other, selectively. This provides a very versatile arrangement. Alternatively, when supplied to the consumer, the identical lower and upper panels (804, 806) are provided with glazings (821) into one of which a user can selectively cut a hole therethrough for mounting of a pet flap (803) in the required configuration. If the glazings (821) are subsequently removable and interchangeable, then the user can later decide to use exactly the same panel pet door (802) in a different hinged orientation, for example by being hinged on the other side simply by inverting the lower and upper panels (804, 806).

Alternatively, the lower panel (804) may have a fixed lower edge which simply is slid downwardly on installation, into engagement with the frame (812) so as to lock the lower panel (804) in position in the frame (812). In this arrangement, the upper and lower panels (806, 804) are not identical and could not be used interchangeably depending on the right-or left-hand opening desired.

In some configurations it is sometimes necessary or desirable for the panel pet door to be installed adjacent to the opening edge (850) of the sliding patio door (814). The opening edge (850) of the sliding patio door (814) is, as shown in FIG. 1, very commonly provided with an inwardly directed handle (852) that protrudes into the room from the plane of the patio door. When the panel pet door is installed adjacent to the opening edge (850) of the sliding patio door (814) with the hinge elements (820) affixed to the opening edge (850), it is not possible to open at least one of the upper or lower panels of the panel pet door, by rotating about the hinge elements, by an angle of 90° so that the opened panel is folded back against the patio door and flush therewith. This is because the hingedly opening lower or upper panel would interfere with the protruding handle (852). In order to overcome this problem, a new hinge structure is provided in accordance with a further aspect of the present invention. This hinge structure can accommodate the presence of an adjacent protruding handle, yet remains substantially flush with the patio door when in a fully closed position when the panel pet door is closed.

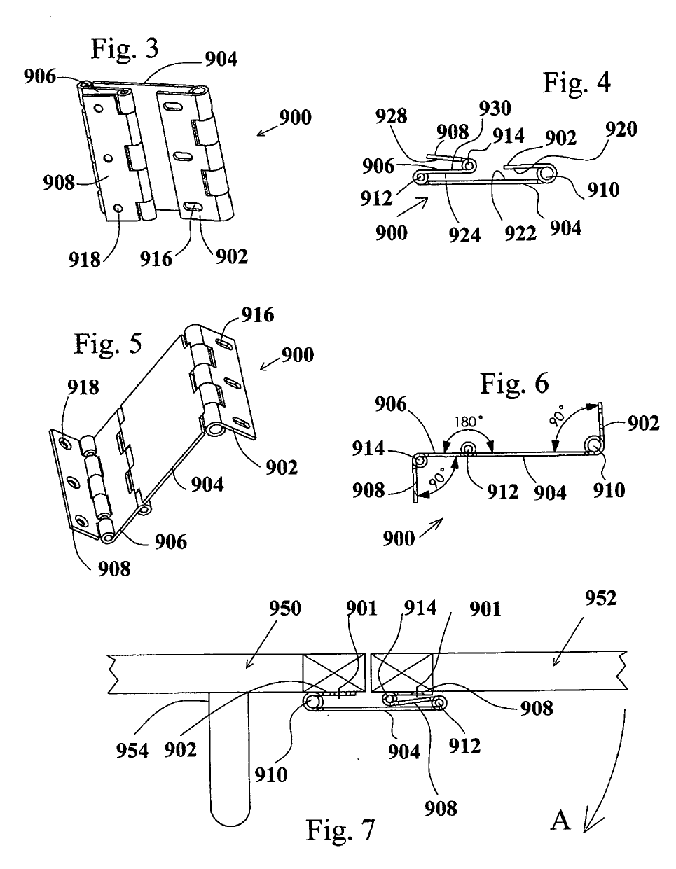

In accordance with this embodiment of the present invention, as shown in FIGS. 3 to 9, the hinge element (900) comprises four interconnected hinge plates (902, 904, 906, 908) serially connected by three parallel hinge axes (910, 912, 914). The hinge element (900) is shown closed in FIGS. 3 and 4 and fully open in FIGS. 5 and 6.

A first end hinge plate (902) is provided with through holes (916) to enable the first end hinge plate (902) to be screwed to the panel pet door or frame. The adjacent first hinge axis (910) between the first end hinge plate (902) and an adjacent first central hinge plate (904) permits the first central hinge plate (904) to be rotated relative to the first end hinge plate (902) by an angle of up to 90°, as shown in FIG. 6. The second hinge axis (912) between the first central hinge plate (904) and a second central hinge plate (906) permits the first and second central hinge plates (904, 906) to be rotated relative to each other by an angle of at least or up to 180°, as shown in FIG. 6. The third hinge axis (914) between the second central hinge plate (906) and the second end hinge plate (908) permits relative rotation therebetween by an angle of up to 90°, as shown in FIG. 6. The second end hinge plate (908) is provided with through holes (918) to enable the second end hinge plate (908) to be screwed to the panel pet door or frame.

When each of the first hinge about first hinge axis (910), the second hinge about second hinge axis (912) and the third hinge about third hinge axis (914) are completely closed, the first end hinge plate (902) and the second end hinge plate (908) are substantially mutually parallel. This means that the panel pet door can be closed about the hinge elements (900) so as to fit within a recess between the patio door frame and the sliding patio door and be coplanar therewith. Conversely, when each of the first hinge about first hinge axis (910), the second hinge about second hinge axis (912) and the third hinge about third hinge axis (914) are completely opened, the first end hinge plate (902) and the second end hinge plate (908) are disposed in different directions but are still substantially mutually parallel. This means that the panel pet door can be opened about the hinge elements (900) so as to be folded back substantially parallel with the patio door with the frame and the sliding door), which is very convenient. If desired, the panel pet door may be over-folded slightly back towards the patio door so that it can be held in its open configuration by a catch between the relevant panel(s) of the panel pet door and the patio door.

When the hinge between the first end hinge plate (902) and the first central hinge plate (904) is closed, the inner surface (920) of the first end hinge plate (902) lies adjacent the inner surface (922) of the first central hinge plate (904). When the second hinge is closed, the inner surface (924) of the second central hinge plate (906) lies adjacent the inner surface (922) of the first central hinge plate (904). When the third hinge is closed, the inner surface (928) of the second end hinge plate (908) lies adjacent the outer surface (930) of the second central hinge plate (906). The width of the second end hinge plate (908) and the second central hinge plate (906) are substantially the same. The width of the first end hinge plate (902) may be substantially the same as the width of the second end hinge plate (908). Accordingly, when the hinge element (900) is in its completely closed configuration, as shown in FIGS. 3 and 4, the first end hinge plate (902) and the combination of the second central hinge plate (906) and the second end hinge plate (908) may be folded so as to lie wholly within the width of the first central plate (904), which is approximately twice the width of any of the other plates, namely the first end hinge plate (902), the second central hinge plate (906) and the second end hinge plate (908).

As shown in FIGS. 7 to 9, the hinge elements (900) are fitted between on the one hand a fixed frame or sliding panel of a patio door (950) and on the other hand a pet panel door (952). In the completely closed configuration of the hinge elements (900), the panel pet door (952) is closed, with the upper and lower panels received within the opening between the patio door frame and the sliding patio door.

When it is desired to open the panel pet door about the hinge elements (900), as shown in FIG. 7, initially the panel pet door (952) is rotated about arrow A so as to open the panel pet door (930) by rotating the first central hinge plate (904) relative to the first end hinge plate (902) about the first hinge axis (910). Since the opening angle of the first hinge about the first hinge axis (910) is limited to a maximum angle, for example 90°, this prevents over rotation of the first central hinge plate (904) which prevents the hinge elements (900) or the panel pet door (952) inadvertently impacting against any handle (954) provided on the sliding patio door (950), as shown in the Figures.

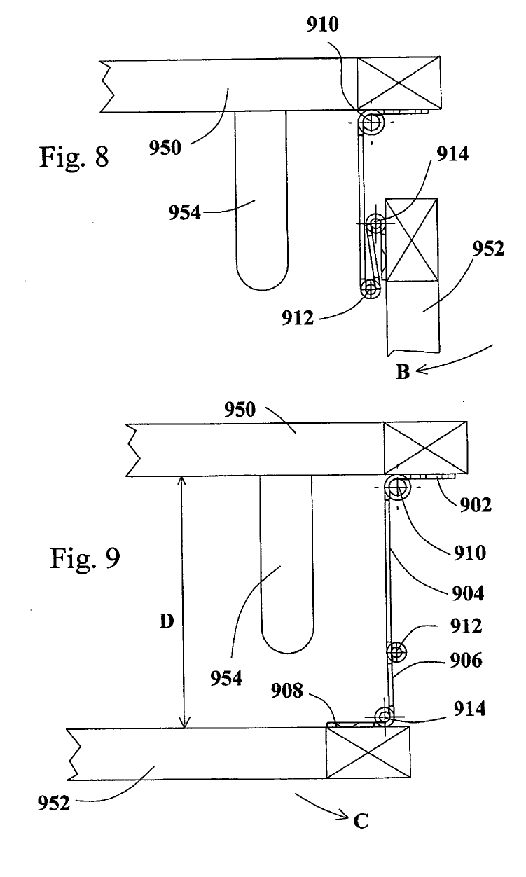

Thereafter, the panel pet door (950) can be rotated further so as to able to be disposed parallel to the fixed or sliding patio door (952). This further rotation is achieved by rotating the second hinge about the second axis (912) in a first rotational direction as shown by arrow B as shown in FIG. 8 and the third hinge about the third axis (914) in an opposite rotational direction as shown by arrow C in FIG. 9. In this way, the second central hinge plate (906) can be disposed linearly aligned with the first central hinge plate (904) so that both are substantially orthogonal to the plane of the patio door. The second end hinge plate (908) is rotated approximately 90° about the third hinge axis (914) so that the panel pet door (952) is substantially parallel to the fixed or sliding patio door (950), and spaced therefrom by a distance D shown in FIG. 9.

This hinge structure therefore provides the advantage that the panel pet door, when opened, can be rotated fully so as to be folded back substantially parallel to the fixed or sliding patio door. The provision of the two central hinge plates, namely the first and second hinge plates, provides the advantage that when linearly aligned, substantially orthogonal to the plane of the patio door, they can together provide a significant spacing between on the one hand the fixed or sliding patio door and on the other hand the folded back panel pet door. This distance is typically at least 70 mm. This distance is sufficient to accommodate the outwardly protruding distance of most commercially available handles provided on a sliding patio door panel. Obviously, the distance may be increased to accommodate even deeper handles by appropriate dimensioning of the first and second central panels. This means that the panel pet door can be opened fully whether or not the panel pet door is provided on the opening edge, provided with a handle, of a sliding patio door panel.

It will be apparent to those skilled in the art that the hinge elements in accordance with the invention may be connected between a panel pet door and a fixed or sliding element of a patio door in a variety of configurations. This provides an extremely versatile mounting arrangement for a panel pet door. As described above, the panel pet door may be fitted either to the sliding door of the patio door or to the fixed frame of the patio door, on either the left hand side or right hand side of either the sliding door of the patio door or the fixed frame of the patio door because the hinges can be used in either rotational direction of opening.

The provision of two separate panels, in the form of an upper panel (806) and a lower panel (804), for a panel pet door (802) not only provides easy shipping and ease of manufacture, but also provides a much more versatile product for the consumer. For example, the consumer can be provided with any selected or desired combination of glazing for the upper panel (806) and sheet for the lower panel (804). For example, the lower sheet could be a glazing, most particularly a plastics glazing having good impact resistance for safety, or opaque, such as of plastics, metal and/or wood or wood-based sheeting, and single or multiply. The lower panel could however be toughened glass if already provided with an appropriately sized and positioned hole for fitting of a pet flap. The lower sheet could be provided with a variety of colors, textures and/or patterns, to be selected by the customer. In addition, the sheet for the lower panel can either be pre-cut with an opening, and associated screw fitting holes if required, for receiving a specific pet flap, or alternatively the sheet could be provided uncut, permitting the purchaser to install any desired make of pet flap in the lower panel at any desired location, merely by cutting an appropriately sized and positioned hole in the lower sheet.

Previous known panel pet doors have a factory installed pet door and glass panel above. In accordance with the invention, by providing a separate lower panel this permits the use of a plastic sheet instead of glass, which is generally used for the upper panel, thereby allowing DIY (do-it-yourself) fitting of the pet door by the consumer. The consumer can fit the pet door at any desired location in the lower panel, and can even fit his or her own pre-owned pet door. Also, the pet door can be supplied separately by the manufacturer, because it does not need to be factory fitted. This means that different pet door models can readily be supplied with the same panel pet door design, and this assists inventory holding and manufacturing by the manufacturer. Therefore the use of a two panel construction with a plastic lower sheet allowing DIY fitting of a number of different pet doors depending on the consumer requirements provides significant commercial and technical advantages.

Some panel pet doors, for example as disclosed in U.S. Pat. No. 6,691,483 (Lethers), require an adjustable bottom rail to accommodate the requirement for different heights for the pet door dependent on the appropriate dog size which varies the length of the dog's legs. Such an additional adjustment structure is not required with the use of a plastic lower panel in accordance with the present invention because the owner can cut the hole to fit the pet door at the required height for their pet.

The preferred embodiments of the present invention therefore provide a panel pet door having two separate glazed panels. One or both of the panels may be made of a plastic enabling the owner to drill, cut and fix a wide variety of pet doors without professional help, in comparison to the case of glass. In contrast, conventional patio panels come prefixed with a pet door giving limited choice to the user unless the user has requested a custom made product at great cost. The panels are identical so that they may be fitted top and bottom and reversed bottom to top. This allows the manufacturer to prefix the hinges on each panel and still retain a left or right opening option by reversing the top and bottom panels. A pet door can be cut to any height into the panel allowing for different leg lengths of pet to safely use the pet door. In contrast, conventional patio doors have to offer a separate patio panel for long legged pets. The hinges may be fitted to either the moving /sliding opening door of the house patio door or to the fixed frame of the house patio door. The hinges may be fitted left or right handed. This provides an exceptionally flexible construction and arrangement as compared to known panel pet doors for insertion into a patio door opening. The hinges allow the patio pet panel to open back flush over the patio door handle. The sliding locking element is used at both the bottom and top of the pet patio door, one sliding part per panel. The sliding locking part is sprung loaded the opposite way to existing patio panels on the market. In other words, when you release the locking knobs the sliding part pulls down/up onto the panel allowing the patio door to swing open on its hinges. In contrast, conventional sliding parts are only to be found at the top of single full length panels and they are biased to push upwards to lock and have to be manually pulled down to release.

What is claimed is:

1. A panel pet door comprising a lower panel and an upper panel disposed above the lower panel to form the panel pet door, a pet flap inserted into the lower panel, the lower and upper panels each having a hinge mechanism on one side thereof so as to have a common hinged edge of the panel pet door, the lower and upper panels being separate, whereby they can be independently opened about the respective hinge mechanism when fitted by the hinged mechanisms within an opening in a patio door, and an upper locking member located along an upper edge of the upper panel and a lower locking member located along a lower edge of the lower panel.

2. A panel pet door according to claim 1 wherein each locking member is a reciprocable biased locking element normally biased to a retracted position by at least one biasing element mounted between the locking element and a frame of the respective panel.

3. A panel pet door according to claim 2 further comprising at least one sliding member within the frame of the respective panel which is connected to the locking element and extends downwardly into the frame and at least one manually operable lock located on a face of the respective frame for locking the respective sliding member in a selected position.

4. A panel pet door according to claim 1 wherein the lower and upper panels have substantially the same height.

5. A kit of parts for a panel pet door, the kit comprising first and second panels, and a locking member located along an end edge of each of the first and second panels.

6. A kit of parts for a panel pet door according to claim 5 wherein the lower and upper panels have substantially the same height.

7. A kit of parts for a panel pet door according to claim 6 further comprising a hinge mechanism on one side of each of the first and second panels whereby when the first and second panels are assembled one above the other with the locking members at opposed ends of the assembly, there is a common hinged edge of the assembled panel pet door.

8. A kit of parts for a panel pet door according to claim 6 wherein each locking member is a reciprocable biased locking element normally biased to a retracted position by at least one biasing element mounted between the locking element and a frame of the respective panel.

9. A kit of parts for a panel pet door according to claim 6 further comprising at least one sliding member within the frame of the respective panel which is connected to the locking element and extends downwardly into the frame and at least one manually operable lock located on a face of the respective frame for locking the respective sliding member in a selected position.

10. A kit of parts for a panel pet door according to claim 6 further comprising a removable glazing for each of the first and second panels.

11. A kit of parts for a panel pet door according to claim 6 further comprising a removable pet flap for fitting to the glazing of one of the first and second panels.

12. A hinge element for a panel pet door comprising four interconnected hinge plates serially connected by three parallel hinge axes.

13. A hinge element according to claim 12 wherein the four interconnected hinge plates comprise a first end hinge plate provided with through screwholes, a first central hinge plate, a second central hinge plate and a second end hinge plate provided with through screwholes, there being a first hinge axis between the first end hinge plate and the first central hinge plate, a second hinge axis between the first central hinge plate and the second central hinge plate, a third hinge axis between the second central hinge plate and the second end hinge plate.

14. A hinge element according to claim 13 wherein the first hinge axis is adapted to permit the first central hinge plate to be rotated relative to the first end hinge plate by an angle of up to 90°.

15. A hinge element according to claim 13 wherein the second hinge axis is adapted to permit the first and second central hinge plates to be rotated relative to each other by an angle of up to about 180°.

16. A hinge element according to claim 13 wherein the third hinge axis is adapted to permit relative rotation between the second central hinge plate and the second end hinge plate by an angle of up to 90°.

17. A hinge element according to claim 13 wherein when each of the first hinge, the second hinge and the third hinge are completely opened, the first end hinge plate and the second end hinge plate are substantially mutually parallel.

18. A hinge element according to claim 13 wherein when the first hinge between the first end hinge plate and the first central hinge plate is closed, a surface of the first end hinge plate lies adjacent a surface of the first central hinge plate, when the second hinge is closed, a first surface of the second central hinge plate lies adjacent the surface of the first central hinge plate, and when the third hinge is closed, a surface of the second end hinge plate lies adjacent a second surface of the second central hinge plate.

19. A hinge element according to claim 13 wherein the width of the second end hinge plate and the second central hinge plate are substantially the same.

20. A hinge element according to claim 13 wherein the width of the first end hinge plate is substantially the same as the width of the second end hinge plate.

21. A hinge element according to claim 13 wherein when the hinge element is in a completely closed configuration the first end hinge plate and the combination of the second central hinge plate and the second end hinge plate are folded so as to lie wholly within the width of the first central plate.

22. A hinge element according to claim 21 wherein the first central plate is approximately twice the width of any of the first end hinge plate, the second central hinge plate and the second end hinge plate.

23. A hinge element according to claim 13 wherein the first hinge axis between the first end hinge plate and the first central hinge plate is of a first hinge which opens in a first rotational direction, the second hinge axis between the first central hinge plate and the second central hinge plate is of a second hinge which opens in a second, opposite, rotational direction, and the third hinge axis between the second central hinge plate and the second end hinge plate is of a third hinge which opens in the first rotational direction.

24. A panel pet door comprising a lower panel and an upper panel disposed above the lower panel to form the panel pet door, a pet flap inserted into the lower panel, the lower and upper panels each having a hinge mechanism on one side thereof so as to have a common hinged edge of the panel pet door, the lower and upper panels being separate, whereby they can be independently opened about the respective hinge mechanism when fitted by the hinged mechanisms within an opening in a patio door, each hinge mechanism comprising at least one hinge element comprising four interconnected hinge plates serially connected by three parallel hinge axes, the four interconnected hinge plates comprising a first end hinge plate, a first central hinge plate, a second central hinge plate and a second end hinge plate, there being a first hinge axis between the first end hinge plate and the first central hinge plate, a second hinge axis between the first central hinge plate and the second central hinge plate, a third hinge axis between the second central hinge plate and the second end hinge plate, and one end hinge plate selected from the group consisting of the first end hinge plate and the second end hinge plate being affixed to the said one side of the respective panel and the other end hinge plate being adapted to be fitted to a patio door.

25. A panel pet door according to claim 24 wherein the lower and upper panels have substantially the same height.

26. A panel pet door according to claim 24 wherein the first hinge axis is adapted to permit the first central hinge plate to be rotated relative to the first end hinge plate by an angle of up to 90°.

27. A panel pet door according to claim 24 wherein the second hinge axis is adapted to permit the first and second central hinge plates to be rotated relative to each other by an angle of up to about 180°.

28. A panel pet door according to claim 24 wherein the third hinge axis is adapted to permit relative rotation between the second central hinge plate and the second end hinge plate by an angle of up to 90°.

29. A panel pet door according to claim 24 wherein when each of the first hinge, the second hinge and the third hinge are completely opened, the first end hinge plate and the second end hinge plate are substantially mutually parallel.

30. A panel pet door according to claim 24 wherein when the first hinge between the first end hinge plate and the first central hinge plate is closed, a surface of the first end hinge plate lies adjacent a surface of the first central hinge plate, when the second hinge is closed, a first surface of the second central hinge plate lies adjacent the surface of the first central hinge plate, and when the third hinge is closed, a surface of the second end hinge plate lies adjacent a second surface of the second central hinge plate.

31. A panel pet door according to claim 24 wherein the width of the second end hinge plate and the second central hinge plate are substantially the same.

32. A panel pet door according to claim 24 wherein the width of the first end hinge plate is substantially the same as the width of the second end hinge plate.

33. A panel pet door according to claim 24 wherein when the hinge element is in a completely closed configuration the first end hinge plate and the combination of the second central hinge plate and the second end hinge plate are folded so as to lie wholly within the width of the first central plate.

34. A panel pet door according to claim 33 wherein the first central plate is approximately twice the width of any of the first end hinge plate, the second central hinge plate and the second end hinge plate.

35. A panel pet door according to claim 24 wherein the first hinge axis between the first end hinge plate and the first central hinge plate is of a first hinge which opens in a first rotational direction, the second hinge axis between the first central hinge plate and the second central hinge plate is of a second hinge which opens in a second, opposite, rotational direction, and the third hinge axis between the second central hinge plate and the second end hinge plate is of a third hinge which opens in the first rotational direction.

36. A kit of parts for a panel pet door, the kit comprising first and second panels, and a hinge mechanism on one side of each of the first and second panels whereby when the first and second panels are assembled one above the other to form a panel pet door, there is a common hinged edge of the assembled panel pet door, each hinge mechanism comprising at least one hinge element comprising four interconnected hinge plates serially connected by three parallel hinge axes, the four interconnected hinge plates comprising a first end hinge plate, a first central hinge plate, a second central hinge plate and a second end hinge plate, there being a first hinge axis between the first end hinge plate and the first central hinge plate, a second hinge axis between the first central hinge plate and the second central hinge plate, a third hinge axis between the second central hinge plate and the second end hinge plate, and one end hinge plate selected from the group consisting of the first end hinge plate and the second end hinge plate being affixed to the said one side of the respective panel and the other end hinge plate being adapted to be fitted to a patio door.

37. A kit of parts for a panel pet door according to claim 36 wherein the lower and upper panels have substantially the same height.

38. A kit of parts for a panel pet door according to claim 36 further comprising a locking member located along an end edge of each of the first and second panels.

39. A kit of parts for a panel pet door according to claim 38 wherein each locking member is a reciprocable biased locking element normally biased to a retracted position by at least one biasing element mounted between the locking element and a frame of the respective panel.

40. A kit of parts for a panel pet door according to claim 39 further comprising at least one sliding member within the frame of the respective panel which is connected to the locking element and extends downwardly into the frame and at least one manually operable lock located on a face of the respective frame for locking the respective sliding member in a selected position.

41. A kit of parts for a panel pet door according to claim 36 further comprising a removable glazing for each of the first and second panels.

42. A kit of parts for a panel pet door according to claim 36 further comprising a removable pet flap for fitting to the glazing of one of the first and second panels.
